(19) United States
(12) Patent Application Publication
(10) Pub. No.: US 2026/0258907 A1
(43) Pub. Date: Sep. 3, 2026

(54) FILLING METHOD WITH OPTIMIZED SCHEDULING

(71) Applicant: L'Air Liquide, Société Anonyme pour l'Etude et l'Exploitation des Procédés Georges Claude, Paris (FR)

(72) Inventors: Karolien SALIOU, Sassenage (FR); Thierry RENAULT, Marines (FR); Rodrigue FOKOUOP-WAFO, Jouy-en-Josas (FR)

(21) Appl. No.: 19/399,027

(22) Filed: Nov. 24, 2025

(30) Foreign Application Priority Data
Dec. 13, 2024 (FR) FR2414127

(51) Int. Cl. F17C 5/00; G05B 13/02; G06Q 50/04

(52) U.S. Cl. CPC F17C 5/002; G05B 13/0205; G06Q 50/04

(57) ABSTRACT

A filling method of a filling installation, including receiving tasks that are to be executed and a set of resources to be used, calculating an adjusted duration of availability, selecting available resources corresponding to the resources to be used, and of selecting the tasks that are to be executed and at least one manufacturing order so that the entire set of tasks that are to be executed from said at least one manufacturing order is selected, defining a complete order of performance of the selected tasks that are to be executed so that the duration for performing each selected task that is to be executed is less than or equal to the duration of availability of the selected available resources, and filling at least part of the plurality of available containers in accordance with the complete order of performance.

### CROSS REFERENCE TO RELATED APPLICATIONS

This application claims the benefit of priority under 35 U.S.C. § 119 (a) and (b) to French Patent Application No. FR 2414127, filed Dec. 13, 2024, the entire contents of which are incorporated herein by reference.

### BACKGROUND

The present invention relates to a filling method with optimized scheduling of filling tasks, and more particularly the invention relates to a method for filling containers that are intended to contain a pressurized fluid. The present invention also relates to a filling system.

Numerous examples of methods for filling containers that are intended to contain a pressurized fluid are known from the prior art.

Application EP2005057A1 discloses one example of a filling method. This method enables at least one compressed-gas container to be filled with at least one gas, a reference compressed-gas container being formed wherein a measurement may be taken of at least one measurement parameter relevant to the state in the reference compressed-gas container. This method thus allows gas mixtures to be created with a high level of precision. By contrast, this method is able neither to manage a set of filling operations nor to optimize the use of the resources necessary for filling.

Also known, from application FR3136831A1, is a method for filling cylinders that enables the filling of a batch of identical cylinders. This filling method is not suitable for filling installations that need to employ a filling method for containers that are different, for example containers that have different capacities. Neither is this method suitable for a filling installation that has to employ a multitude of gases, or mixtures of gases. Moreover, this method of the prior art does not allow optimized use of the installation's resources, for example filling manifolds or filling tools.

Also known, from application FR2811909A1, is a cylinder-filling method for a gas conditioning installation have a number of branched gas lines. This method of the prior art does not seek to optimize the scheduling of the filling operations. Moreover, this method of the prior art is also unable to allow optimized use of the installation's resources, for example filling manifolds or filling tools.

A user of a filling method may have to manage a very large number of resources during filling operations, for example a large number of containers, of gases, or else of tools present at the conditioning/filling centre. Furthermore, each filling operation involves various operations/tasks. The user may make poor decisions in the filling operations. Sometimes these decisions lead to delays in delivery, or else to errors such as the use of the wrong tool or the wrong container. There is no method in the prior art that is able to take the above-mentioned constraints into consideration and allow simple implementation of a filling method involving multiple operations/tasks and multiple resources.

The present invention seeks to effectively overcome the disadvantages of the methods of the prior art by proposing a filling method that allows a set of tasks with multiple resources to be carried out in a simple and optimized way.

The invention thus relates to a filling method of a filling installation, the installation comprising a set of resources referred to as being available, the set of available resources comprising:
at least a first available fluid source,
a plurality of containers available to be filled,
at least one available fluid-transfer circuit intended to be fluidically connected by a first end to a container and by a second end to the at least one first fluid source so as to allow at least part of the plurality of containers to be filled with the fluid,
   the filling method comprising the following steps:
a) receipt of descriptive data for the filling, the descriptive data comprising:
   a plurality of manufacturing orders, each manufacturing order defining a set of tasks that are to be executed in a predefined order of performance,
   durations for performing each of the tasks that are to be executed,
   a set of resources referred to as being those to be used, comprising at least a first fluid source (1) to be used, at least one container to be used, at least one fluid-transfer circuit (3) to be used, each resource to be used being able to perform at least one task that is to be executed for at least partly filling the plurality of containers to be used,
   a duration of availability for each available resource,
   an adjustment index comprised between 0 and 1 for each of the resources to be used.
b) calculation of what is referred to as an adjusted duration of availability for each available resource, the adjusted duration of availability being equal to the duration of availability multiplied by the adjustment index,
c) selection of the available resources corresponding to the resources to be used, selection of the tasks that are to be executed using the available resources referred to as selected available resources, selection of at least one manufacturing order so that the entire set of tasks that are to be executed from said at least one manufacturing order is selected,
d) definition of a complete order of performance of at least two selected tasks that are to be executed, so that:
   for each selected task that is to be executed in a selected manufacturing order, the duration for performing said selected task that is to be executed is less than or equal to said duration of availability of said associated resource,
   the predefined order of performance is conformed to,
e) filling at least part of the plurality of available containers in accordance with the complete order of performance.

Depending on the case, the invention may comprise one or more of the features set out below:

Step a) comprises identifying at least one task that is to be executed that is in the process of being performed, available resources for performing the task that is to be executed that is in the process of being performed, a duration referred to as remaining duration for completing the task that is to be executed that is in the process of being performed, and the adjustment index of at least one available resource from among the set of usable resources is configured to be less than 1 as long as the remaining duration is other than 0.

Step a) comprises identifying the set of tasks that are to be executed in the course of fulfilling a selected manufacturing order, resources available for performing the set of tasks that are to be executed in the course of fulfilling a selected manufacturing order, durations referred to as remaining durations for completing each task of the set of tasks that are to be executed in the process of being performed, and the adjustment indices of the available resources are configured to be less than 1 as long as the remaining durations are other than 0.

Step a) comprises receipt of a predetermined planning duration and step d) defines the order of performance in the predetermined planning duration.

The method of the invention comprises a step d) of determining what is referred to as a remaining duration of availability for each of the selected available resources, each remaining duration of availability being respectively equal to the duration of availability of each selected available resource minus the sum of the durations for performing the at least two tasks that are to be executed with each of the selected available resources, and said method comprises a step e) of repeating said steps b), c) and d) so that the remaining duration of availability of each of the selected available resources is minimized.

The relative difference between at least the durations referred to as remaining durations of two available resources is less than 5%.

Step a) comprises receipt of an indicator of priority of each manufacturing order from among the plurality of manufacturing orders and the order of performance conforms to said priority indicator.

The steps of the filling method are performed when at least one new available container is added to the set of available resources.

The steps of the filling method are performed at a predetermined periodicity of between 1 minute and 180 minutes.

The filling method comprises a step of transmitting, to a visualization device, an ordered list scheduling at least two tasks that are to be executed and/or the selected available resources.

The filling method comprises a step of identifying unscheduled manufacturing orders and resources to be used suitable for performing the tasks that are to be executed in the unscheduled manufacturing orders and in that the filling method comprises a step of transmitting, to the visualization device, a list of the unscheduled manufacturing orders and/or a list of the resources to be used suitable for performing the tasks that are to be executed in the unscheduled manufacturing orders.

The priority indicator is indexed to a predetermined maximum date of fulfilment of the manufacturing order.

At least one available resource referred to as a shared resource from among the set of available resources is configured to perform simultaneously a plurality of tasks that are to be executed.

At least one container comprises an identification device, for example a radio-frequency identification label, and in that step a) allows the receipt of the descriptive data regarding the at least one container to be used by means of the identification device.

The invention also relates to a filling system for pressurized-fluid containers comprising an information device, a computer program, a set of available resources comprising at least:
a first available fluid source,
a plurality of containers available to be filled,
an available fluid-transfer circuit intended to be fluidically connected by a first end to a container and by a second end to the at least first fluid source so as to allow the container to be filled with the fluid,
   and that the computer program executes the steps of the filling method of the invention and the receipt of descriptive data in step a) is performed by means of said information device.

Depending on the case, the filling system of the invention may comprise one or more of the features set out below:

The computer program is configured to execute said steps a) to d) using constraint programming.

### BRIEF DESCRIPTION OF THE DRAWING

The invention will be better understood on reading the following description and on studying the accompanying figure. This figure is given only by way of illustration and does not in any way limit the invention.

FIG. 1 is a schematic depiction of the filling installation for implementing the invention.

### DETAILED DESCRIPTION OF THE PREFERRED EMBODIMENTS

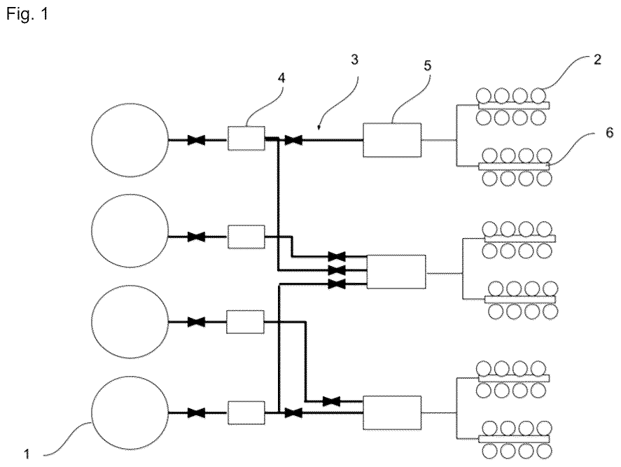

With reference to FIG. 1, the filling installation comprises a set of available resources. The resources are, for example, filling manifolds 6, manifold-provisioning tools 5, pumps 4 and fluid sources 1. The resources are also for example containers intended to contain pressurized gas, for example gas cylinders. An available resource is a resource that can be used to perform a task, for example a filling manifold 6 may be available for performing the task of filling a container 2. This set of resources notably comprises at least a first available fluid source 1. The fluid source 1 may for example be a gas cylinder, the storage tank of a truck, or else an air separation unit. The fluid may be a gas selected from oxygen, nitrogen, argon, carbon dioxide, a rare gas, or else a mixture of these gases. The set of resources also comprises a plurality of containers 2 available to be filled. These containers 2 are for example empty or part-full. There are at least two of the containers 2. The containers 2 are for example cylinders intended for conditioning pressurized gas. The containers 2 may have different pressures, for example the containers 2 are 50 to 300-bar cylinders. The set of resources also comprises at least one available fluid-transfer circuit 3. This fluid-transfer circuit 3 is intended to be fluidically connected by a first end to a container 2 and by a second end to said at least one first fluid source 1. For example, a fluid-transfer circuit 3 comprises at least one gas-conveying line which fluidically connects the source 1, a pump 4, a tool 5, a filling manifold 6 and a container 2. Thus, when the containers 2 and the fluid source 1 are in fluidic communication, it is possible to fill at least part of said plurality of containers with the fluid. The set of resources may comprise other resources such as the protective bonnet that protects the containers 3 or else a pressure regulating valve.

The filling installation enables implementation of the filling method which comprises the following steps:

First of all, there is a step a) of receipt of descriptive data for carrying out the filling.

The descriptive data comprise for example the production plan, namely a list of the containers to be filled coming from customer orders or replenishment requirements. These lists take the form of manufacturing orders that indicate the number of containers to be filled with a type of gas. Each manufacturing order requires a certain number of tasks that are to be executed in order to fulfil it, namely so that the number of containers indicated on the manufacturing order is filled with the desired fluid. These descriptive data thus comprise a plurality of manufacturing orders. The tasks that are to be executed are, for example, connecting the tool 5 to the filling manifold 6 when the manifold 6 is notably a mobile manifold 6, switching on the gas mixture, purging the system or the container 2, filling a container 2, and disconnecting the container 2 from the manifold 6.

These tasks need to be performed in a predefined order of performance, namely in an order that is defined in advance by the user of the filling method. For example, an operator has to connect the container 2 to the filling manifold 6 before the container 2 can be filled. This predefined order may for example be stored in memory for each manufacturing order to be fulfilled. The descriptive data comprise this predefined order for each manufacturing order.

The descriptive data also comprise durations for performing each of the tasks that are to be executed. Thus, each task has to be executed inside a certain duration.

These descriptive data also comprise a set of resources referred to as resources to be used, meaning that the resources of this set are the resources to be used to perform each task that is to be executed in the manufacturing orders. This set of resources referred to as being those to be used comprises at least a first fluid source 1 to be used, at least one container 2 to be used, and at least one fluid-transfer circuit 3 to be used. Each resource to be used is able to perform at least one task that is to be executed for at least partly filling said plurality of containers to be used. For example, a particular resource may be the one to use for a particular task. An oxygen fluid source 3 is to be used for performing the task of filling a container 2 with oxygen. Certain tools 5 may be configured so that they are compatible only with a certain filling manifold 6 for example.

These descriptive data also comprise durations of availability for each available resource. This duration corresponds to the availability of the resource to perform the task. The availability or otherwise of the resources may be estimated manually or automatically. For example, the duration of availability is indicated by the user or else may be calculated on the basis of the nature of the resource.

These descriptive data also comprise an adjustment index comprised between 0 and 1 for each of the resources to be used. This adjustment index makes it possible to define constraints on the use of the resources. This adjustment index is defined by the user; it may differ according to the resource to be used, for example according to whether the resource is a container 2 or a filling manifold 6. For example, if a maintenance operation on the conditioning site is planned, the filling manifold 6 or the tool 5 is not 100% available. For example, the resource is available for only part of the planning period. This availability is reduced for example by 50% and so the adjustment index is 0.5.

The filling method next comprises a step b) of calculating what is referred to as an adjusted duration of availability for each available resource. The adjusted duration of availability is equal to the duration of availability multiplied by the adjustment index. This step enables a constraint to be applied to the available resource.

The filling method next comprises a step c) of selecting the available resources corresponding to the resources to be used, these then being selected available resources. Thanks to this selection, a selection is made of the tasks that are to be executed using said selected available resources. Thus, only those tasks that can be performed with the selected available resources are selected. This step makes it possible to reduce user errors, such as the error of beginning a task that is to be executed but that cannot be accomplished as a result of non-availability of a resource. Finally, at least one manufacturing order is selected so that the entire set of tasks to be executed in the manufacturing order is selected. Thus, only those manufacturing orders for which all the tasks can be performed are selected. This step guarantees the reliability and the quality of the filling. Thus, a manufacturing order is guaranteed to be able to be completed using these selections. Furthermore, thanks to this step, the containers 2 are filled with the gas specified in the manufacturing order, and more particularly in the tasks that are to be executed. For example, a manufacturing order comprises these tasks that are to be executed: moving the containers 2 to a manifold 6, connecting the carbon dioxide source 3 to a pump 4, connecting a tool 5 to the pump 4 and the filling manifold 6, connecting containers 2 to the filling manifold 6, selecting to fill the containers 2 with fluid, for example carbon dioxide, disconnecting the containers 2 from the manifolds 6, moving the containers 2 to a storage zone. Other tasks may be performed, such as: choosing the gas mixture or the single gas, starting the filling, testing the filling, testing the conformity of the filling performed. If the resources are available, if there is therefore, for example, enough carbon dioxide in the fluid source 1, containers 2, manifold 6, tool 5 and pump 4 available, then all the tasks that are to be executed in the manufacturing order are able to be performed. All of the tasks that are to be executed in this manufacturing order can be selected.

The filling method then comprises a step of defining a complete order of performance. This complete order of performance comprises at least two tasks that are to be executed that have been selected in step c). Each selected task that is to be executed is also associated with at least one selected available resource, referred to as associated resource.

This definition step is performed in such a way that, for each selected task that is to be executed in a selected manufacturing order, the duration for performing the selected task that is to be executed is less than or equal to the adjusted duration of availability of the at least one associated resource. Thus, the capacity of each associated resource is not exceeded. The user thus has the guarantee for example that each associated resource is available to perform the entirety of the selected task that is to be executed, if this task requires only this resource. If, for example, the selected task that is to be executed requires two associated resources, the method makes it possible to guarantee that these two resources are available for performing the entirety of the selected task.

The definition step is thus performed in such a way that the predefined order of performance is conformed to. Thus, if one task that is to be executed is preceded by a preceding step, the preceding step therefore has to be performed before the step that is to be executed. For example, a preceding task that is to be executed consists in connecting the container 2 to the filling manifold 6 and the task that is to be executed consists in filling the container 2. With the method of the invention the user obtains a complete order of performance specifying that the preceding task has to be executed before the task that is to be executed. Thus, the connecting of the container 2 to the manifold 6 is scheduled to occur before the task of filling the container 2. This step makes it possible to avoid resource handling errors and therefore wasted time or filling errors.

In one embodiment, the method of the invention may comprise a step of determining association of available resources. A first resource is associated with a secondary resource in order to perform a task that is to be executed. For example, a filling manifold 6 is associated with one tool or with a plurality of tools 5.

The filling method next comprises a step of filling at least part of the plurality of available containers 2 in accordance with the complete order of performance. Thus, a set of tasks is scheduled into an order that guarantees the user optimal and reliable use of the resources. Furthermore, thanks to the method of the invention, there is no needless operation. For example, all of the containers 2 connected to a filling manifold 6 are filled. Moreover, thanks to the method of the invention, there is no error in the selection of resources, and so the containers 2 are filled with the gas specified in the descriptive data.

In one embodiment, step a) comprises identifying at least one task that is to be executed that is in the process of being performed, available resources for performing said task that is to be executed that is in the process of being performed, a duration referred to as remaining duration for completing the task that is to be executed that is in the process of being performed. The adjustment index for at least one available resource from said set of resources to be used is configured to be less than 1 as long as said remaining duration is other than 0. This embodiment makes it possible, for example, to ensure that a container is not added to a filling manifold. This for example makes it possible for the filling manifold to be assigned to the one single task. Such may be the case for example for filling with certain gases. It is therefore necessary for resources to be assigned to this filling. This embodiment may thus allow an operator to be assigned to a task. The user of the method of the invention may wish to perform only one task with a resource even if it is physically possible for two tasks to be performed simultaneously. In this embodiment, the adjustment index may alternatively be a fictional task to be performed which is allocated, for example over a predetermined period of time, to the resources to be used. The fictional task is, for example, a task may be an example of a previously listed task.

In one embodiment, step a) comprises identifying the entire set of tasks that are to be executed in the course of fulfilling a selected manufacturing order, resources available for performing the set of tasks that are to be executed in the course of fulfilling a selected manufacturing order, durations referred to as remaining durations for completing each task of the set of tasks that are to be executed in the process of being performed. The adjustment indices of the available resources are configured to be less than 1 as long as the remaining durations are other than 0. This embodiment makes it possible for example to assign an operator to a manufacturing order. This embodiment also makes it possible for example to assign an operator to two manufacturing orders when the two manufacturing orders relate to the same gas or mixture of gases. This makes it possible to minimize operational errors and therefore for example guarantee the quality of the mixtures and of the filling. This embodiment makes it possible to assign a set of resources to one single manufacturing order. Such may be the case for example for filling with certain gases. The user of the method of the invention may have reason to want to fulfil just one manufacturing order with certain resources even if it is physically possible for two manufacturing orders to be fulfilled simultaneously. It may also be the one same tool that fulfils a set of manufacturing orders. Thus, the user saves time, for example by avoiding the need for multiple setups. In this embodiment, the adjustment index may alternatively be a fictional task to be performed which is allocated, for example over a predetermined period of time, to the resources to be used.

In one embodiment, the set of tasks comprises two from among: connecting the fluid-transfer circuit 3 to the container 2 or to the first fluid source 1, purging the container 2, filling the container 2, disconnecting the fluid-transfer circuit 3 from the container 2 or from the first fluid source 1.

In one embodiment, step a) of the method comprises receipt of a predetermined planning duration. This predetermined planning duration is the length of time during which the tasks that are to be executed may be executed. It is set by the user for example by means of a human-machine interface; this planning duration may be stored in memory by the filling installation. The user may for example wish to plan for forty-eight hours, or a week, or even a month. Next, during step c), the complete order of performance is defined in this predetermined planning duration. Thus, the complete order of performance comprises tasks that can be performed during this predetermined planning duration.

In one embodiment, step a) of the method comprises receipt of an indicator of priority of each manufacturing order from among the plurality of manufacturing orders. This priority indicator is for example set by a user and stored in memory by the filling installation. In one embodiment, the priority indicator is indexed to a predetermined maximum date of fulfilment of the manufacturing order. This priority indicator may in other words be a latest finish date. Thus, a manufacturing order to be completed before 31 March of year N takes priority over another manufacturing order to be finished before 30 April of the same year N. The defined complete order of performance conforms to the priority indicator and therefore schedules the tasks that are to be executed in such a way that the manufacturing order that is to be completed soonest is fulfilled before the other manufacturing order.

In another embodiment, the method comprises an additional step of determining what is referred to as a remaining duration of availability of each of the selected available resources. The remaining duration of availability is equal to the duration of availability of each selected available resource minus the sum of the durations for performing the tasks that are to be executed with each of the selected available resources. Thus, when an available resource has been assigned, which is to say selected, for a task that is to be executed, the usage of the resource is estimated. A remaining capacity, namely the duration of availability of the resource from which the duration of execution has been subtracted, is then defined. The method then also comprises a step of repeating steps b), c) and the step of determining the remaining durations of availability. This repeating step is performed so that the remaining duration of availability of each of the selected available resources is minimized. In this way, the filling method optimizes the use of the resources while allowing maximum utilization of the resources. For each available resource of the installation, the duration of availability is the duration for which it is possible to use that resource. For example, one available resource may be available for eight hours of the day, and another available resource available for five hours. Thus, if a task that is to be executed requires the one resource or the other resource for one hour, the filling method of the invention gives precedence to the use of the other resource for which the remaining duration of availability is shorter after the complete order of performance has been defined. In one embodiment, it is an available quantity that is calculated, for example a quantity, expressed as a pressure, of fluid coming from the source 3. Thus, what is calculated is a remaining available quantity. The method of the invention therefore ensures optimal usage of the fluid sources 3. That may for example make it possible to avoid handlings of containers. Furthermore, the method ensures that the selected resources are sufficient to perform the filling.

In one embodiment, the relative difference between at least the durations referred to as remaining durations of two available resources is less than a predetermined percentage. Thus it is possible to balance the load on the resources. For example, that makes it possible to avoid premature wearing of one tool in comparison with another tool. This embodiment makes it possible for example for two operators to have the same workload.

In one embodiment, the steps of the filling method are performed when at least one new available container is added to said set of available resources. For example, a new container may be delivered to the filling centre that is in the process of performing the tasks that are to be executed as scheduled by the filling method. Specifically, in a filling centre, baskets of cylinders or individual cylinders are transported. These cylinders are therefore in transit, for example returning from a customer site. Systems capable of analysing the presence of these containers in transit or of any other resource, may also be present at the filling centre. Thus, these detection systems may detect whether a new container is available on the site. These systems are, for example, an image processing system processing images from cameras positioned at the filling centre/on the filling site. These systems make it possible for example to update the descriptive data as soon as they detect a new container. Moreover, at a filling site there may be both containers that have been sorted and those that have not been sorted, namely containers the status of which has not been verified. There may also be containers for which the user does not know the volume capacity or gas content. The containers that have not been sorted are therefore not available for performing a task that is to be executed. As soon as a container, for example a cylinder, has been sorted, it is added to the set of available resources. For example, once sorted, cylinders intended to be conditioned with fluid can be scanned by the operators. As soon as a new cylinder has been scanned, the information is transmitted to an information device that updates the descriptive data. The entire set of steps of the method of the invention is then carried out. Thus, a maximum of tasks that are to be executed are scheduled to allow a maximum number of containers 2 to be filled.

In one embodiment, the steps of the filling method are performed at a predetermined periodicity of at least once per day. In one embodiment, the steps of the filling method are performed at a predetermined periodicity of at least twice per day. In one embodiment, the steps of the filling method are performed at a predetermined periodicity of at least once every three hours. In one embodiment, the steps of the filling method are performed at a predetermined periodicity of between 1 minute and 180 minutes. The user thus has the guarantee of best optimizing the use of their resources. For example, in the event of a problem with quality, the breakage of a resource or else a maintenance operation on a selected available resource, the updating of the complete order of performance is able to take into account an update of the available resources. Furthermore, this approach of performing the steps of the method at a predetermined periodicity allows optimal management of the filling method, thus allowing a maximum number of manufacturing orders to be fulfilled and therefore a maximum number of containers 2 to be filled.

In one embodiment, the scheduling method may also allow an updating, namely the performance of the entire set of steps of the method of the invention, on demand or after an incident has occurred. For example, when a new resource, different from a container 2, becomes available or when a new manufacturing order is introduced, or else if the number of resources for performing a task that is to be executed is sufficient. Thus, the complete order of performance is optimized and notably the utilization of resources is optimized so that there is very little standby time spent awaiting the use of these resources. Furthermore, the scheduling method of the invention allows the scheduling plan, the complete order of performance, to be optimally adjusted so as to optimize the utilization of the resources and a maximum number of containers is thus filled. Moreover, the user can obtain real-time information about the possible planning of the operations and of the tasks that are to be performed. This guarantees operational feasibility of the production plan, namely the feasibility of being able to fulfil the manufacturing orders.

In one embodiment, step a) comprises identifying at least one task that is to be executed that is in the process of being performed, available resources for performing the task that is to be executed that is in the process of being performed, and a duration referred to as remaining duration for completing the task that is to be executed that is in the process of being performed. The duration of availability of each of the selected available resources is reduced by the remaining duration for completing said task that is to be executed that is in the process of being performed. When the filling method is begun, tasks that are to be executed are in progress at the conditioning centre and it is therefore necessary to calculate the remaining capacity of each resource associated with this task. This remaining capacity, the new calculated duration of availability, is also introduced into the descriptive data.

In one embodiment, the method comprises a step of transmitting, to a visualization device, an ordered list scheduling at least two tasks that are to be executed and/or the selected available resources. The visualization device is for example a computer screen. This step makes it possible to visualize the tasks that are to be executed together with the complete order of performance generated by the filling method. Thus, the user is able as quickly as possible to adjust their installation to conform to this scheduling plan and thus optimize the utilization of the resources in terms of capacity. In one embodiment, the ability to visualize the tasks that are to be executed may also allow production to be monitored in real-time by displaying the list of the tasks already executed and therefore of the manufacturing orders fulfilled. In another embodiment, this visualization may also make it possible to determine whether resources are in the process of being used or about to be used. That makes it possible to avoid resource handling errors for example.

In one embodiment, the filling method comprises a step of identifying unscheduled manufacturing orders and resources to be used suitable for performing the tasks that are to be executed in said unscheduled manufacturing orders. The method also comprises a step of transmitting, to a visualization device, a list of the unscheduled manufacturing orders and/or a list of the resources to be used suitable for performing the tasks that are to be executed in the unscheduled manufacturing orders. For example, this list of resources may allow the user to plan a priority search of listed resources, for example by means of a sorting step. Specifically, the unscheduled manufacturing orders are still to be scheduled and need to be fulfilled as part of the filling centre production organization. If a resource is missing, the user needs to find a resource using this sorting step. In one embodiment, the list of resources is ordered with the priority indicator. For example, the list may indicate particular containers 2 to the user. The order of this list allows the user to sort to ensure the availability of the resources for the filling. In one embodiment, the definition step is performed in such a way that the number of manufacturing orders or the number of tasks that are to be executed that are not scheduled is minimized.

The step of sorting, for example the containers 2, also makes it possible to ensure for example that the resource is suitable for a new filling operation. For example, that the resource is not defective, is not damaged. The sort comprises for example a step of visual inspection or of non-destructive testing followed by a step of grouping together the available resources that have been sorted. For example, the operator groups together those resources that are intended to fill with the same fluid or fluid mixture. The sort may be performed either manually or via a semiautomated system.

In one embodiment, at least one available resource from among the set of available resources is referred to as a shared resource. This shared resource is configured to perform simultaneously a plurality of tasks that are to be executed. As illustrated in FIG. 1, a pump 4 or a tool 5 may, for example, depending on its configuration, be intended to perform two different filling tasks. A pump 4 (or a tool 5) may be connected to two different manifolds 6. The pump 4 (or the tool 5) is thus able to at least partially feed a supply to the two filling manifolds 6. The containers 2 connected to the filling manifolds 6 are then filled with, for example, different gases or gas mixtures. In another example, two different manufacturing orders define tasks that are to be executed that include the filling of containers with the same gas or gas mixture. If the duration of availability of the resources is sufficient, then the method of the invention allows the pump 4 (or the tool 5) to be selected for performing two tasks that are to be executed at the same time.

In one embodiment, at least one container comprises an identification device, for example a radio-frequency identification label, and in that said step a) allows said receipt of said descriptive data regarding said at least one container 3 to be used by means of the identification device. For example, the resources may comprise an identification device, for example a label of the RFID (Radio Frequency Identification) type stuck for example to a gas cylinder. Sensors may also be fixed in place at the filling centre; for example these may be sensors capable of reading identification devices such as the RFID labels. Moreover, in one embodiment, as soon as a new cylinder container with an RFID label is added to the set of available resources and detected by an information device, steps a) to c) of the method of the invention are implemented.

The invention also relates to a filling system for pressurized-fluid containers. This filling system comprises an information device, a computer program, and a set of available resources comprising at least a first available fluid source 1, a plurality of containers 2 available to be filled, an available fluid-transfer circuit 3 intended to be fluidically connected by a first end to a container 2 and by a second end to said at least first fluid source 1 so as to allow the container to be filled with the fluid. The computer program then executes at least steps a) to d) of the filling method of the invention. Step a) of receiving descriptive data is performed by means of an information device. In one embodiment, step e) of filling is performed by means of the computer program.

In one embodiment, the computer program is configured to execute steps a) to c) using constraint programming. Constraint programming is a form of artificial intelligence that allows the user to specify conditions that have to be met. The program, or solver, then looks for the best solution that conforms to these constraints.

In the method of the invention, the constraints are, for example:
for each selected task that is to be executed in a selected manufacturing order, the duration for performing the selected task that is to be executed is less than or equal to the duration of availability of each of the selected associated resources,
the predefined order of performance is conformed to,
the priority order is conformed to, or else
the planning duration is conformed to.

The user may intervene to change the constraints, for example by means of a human-machine interface, or HMI, that enables the constraints to be input in the form of instructions to the program implementing the invention. Thus, steps a) to c) are performed quickly. Above all, the complete order of performance thus defined is the solution best able to conform to the constraint or constraints.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A filling method of a filling installation, the installation comprising a set of resources referred to as being available, the set of available resources comprising:
at least a first available fluid source,
a plurality of containers available to be filled,
at least one available fluid-transfer circuit configured to be fluidically connected by a first end to a container and by a second end to the at least one first fluid source thereby allowing at least part of the plurality of containers to be filled with the fluid,
the filling method comprising the following steps:
a) receiving descriptive data for the filling, the descriptive data comprising:
a plurality of manufacturing orders, each manufacturing order defining a set of tasks that are to be executed in a predefined order of performance,
durations for performing each of the tasks that are to be executed,
a set of resources referred to as being those to be used, comprising at least a first fluid source to be used, at least one container to be used, at least one fluid-transfer circuit to be used, each resource to
be used being able to perform at least one task that is to be executed for at least partly filling the plurality of containers to be used,
a duration of availability for each available resource,
an adjustment index comprised between 0 and 1 for each of the resources to be used,
b) calculating what is referred to as an adjusted duration of availability for each available resource, the adjusted duration of availability being equal to the duration of availability multiplied by the adjustment index,
c) selecting the available resources corresponding to the resources to be used, selection of the tasks that are to be executed using the available resources referred to as selected available resources, selection of at least one manufacturing order so that the entire set of tasks that are to be executed from the at least one manufacturing order is selected,
d) defining a complete order of performance of at least two selected tasks that are to be executed, each task that is to be executed being associated with at least one of the selected available resources referred to as associated resources, so that:
for each selected task that is to be executed in a selected manufacturing order, the duration for performing the selected task that is to be executed is less than or equal to the duration of availability of the associated resource,
the predefined order of performance is conformed to,
e) filling at least part of the plurality of available containers in accordance with the complete order of performance.

2. The filling method according to claim 1, wherein the step a) comprises identifying at least one task that is to be executed that is in the process of being performed, available resources for performing the task that is to be executed that is in the process of being performed, a duration referred to as remaining duration for completing the task that is to be executed that is in the process of being performed, and the adjustment index of at least one available resource from among the set of usable resources is configured to be less than 1 as long as the remaining duration is other than 0.

3. The filling method according to claim 1, wherein the step a) comprises identifying the set of tasks that are to be executed in the course of fulfilling a selected manufacturing order, resources available for performing the set of tasks that are to be executed in the course of fulfilling a selected manufacturing order, durations referred to as remaining durations for completing each task of the set of tasks that are to be executed in the process of being performed, and the adjustment indices of the available resources are configured to be less than 1 as long as the remaining durations are other than 0.

4. The filling method according to claim 1, wherein the step a) comprises receipt of a predetermined planning duration and the step d) defines the order of performance in the predetermined planning duration.

5. The filling method according to claim 1, wherein the method comprises a step d) of determining what is referred to as a remaining duration of availability for each of the selected available resources, each remaining duration of availability being respectively equal to the duration of availability of each selected available resource minus the sum of the durations for performing the at least two tasks that are to be executed with each of the selected available resources, and the method comprises a step e) of repeating the steps b), c) and d) so that the remaining duration of availability of each of the selected available resources is minimized.

6. The filling method according to claim 5, wherein the relative difference between at least the durations referred to as remaining durations of two available resources is less than 5%.

7. The filling method according to claim 1, wherein the step a) comprises receipt of an indicator of priority of each manufacturing order from among the plurality of manufacturing orders and the order of performance conforms to the priority indicator.

8. The filling method according to claim 1, wherein the steps of the filling method are performed when at least one new available container is added to the set of available resources.

9. The filling method according to claim 1, wherein the steps of the filling method are performed at a predetermined periodicity of between 1 minute and 180 minutes.

10. The filling method according to claim 1, further comprising a step of transmitting, to a visualization device, an ordered list scheduling at least two tasks that are to be executed and/or the selected available resources.

11. The filling method according to claim 10, further comprising a step of identifying unscheduled manufacturing orders and resources to be used suitable for performing the tasks that are to be executed in the unscheduled manufacturing orders and in that the filling method comprises a step of transmitting, to the visualization device, a list of the unscheduled manufacturing orders and/or a list of the resources to be used suitable for performing the tasks that are to be executed in the unscheduled manufacturing orders.

12. The filling method according to claim 3, wherein the priority indicator is indexed to a predetermined maximum date of fulfilment of the manufacturing order.

13. The filling method according to claim 1, wherein at least one available resource referred to as a shared resource from among the set of the available resources is configured to perform simultaneously a plurality of tasks that are to be executed.

14. The filling method according to claim 1, wherein at least one container comprises an identification device, for example a radio-frequency identification label, and in that the step a) allows the receipt of the descriptive data regarding the at least one container (3) to be used by means of the identification device.

15. A filling system for pressurized-fluid containers comprising an information device, a computer program, a set of available resources comprising at least:
a first available fluid source,
a plurality of containers available to be filled,
an available fluid-transfer circuit configured to be fluidically connected by a first end to a container and by a second end to the at least first fluid source so as to allow the container to be filled with the fluid,
wherein the computer program executes the steps of the filling method according to claim 1 and the receipt of descriptive data in the step a) is performed by means of the information device.

16. The filling system for pressurized-fluid containers according to claim 14, wherein the computer program is configured to execute the steps a) to c) using constraint programming.
